(19) United States
(12) Patent Application Publication
(10) Pub. No.: US 2016/0085848 A1
(43) Pub. Date: Mar. 24, 2016

(54) CONTENT CLASSIFICATION

(71) Applicant: HEWLETT-PACKARD DEVELOPMENT COMPANY, L.P., Houston, TX (US)

(72) Inventors: Hadas Kogan, Zichron Yaacov (IL); Doron Shaked, Tivon (IL); Sivan Albagli KIM, Haifa (IL); George Forman, Port Orchard, WA (US)

(21) Appl. No.: 14/787,877

(22) PCT Filed: May 1, 2013
(86) PCT No.: PCT/US2013/039055

§ 371 Date: Oct. 29, 2015

(51) Int. Cl. G06F 17/30

(52) U.S. Cl. CPC G06F 17/30601

(57) ABSTRACT

Techniques for determining classifications from content of data objects (100) are disclosed. Terms from the content of one or more data objects (100) of each of a plurality of classes (200) are used to determine a sub-topic (210) for one of the classes (200).

### BACKGROUND

Classification systems are used to classify content of data objects such as documents, email messages and web pages and also to support processing of sets of data objects.

### BRIEF DESCRIPTION OF THE DRAWINGS

The accompanying drawings illustrate various examples and are a part of the specification. The illustrated examples are examples and do not limit the scope of the claims. Throughout the drawings, identical reference numbers designate similar, but not necessarily identical elements.

FIG. 1 is a block diagram of a system according to various examples;

FIG. 2 is a schematic diagram illustrating elements of a data object 100, according to various examples;

FIG. 3 is a block diagram of a system according to various examples;

FIG. 4 is a flow diagram of a method according to various examples;

FIG. 5 is a block diagram of a system according to various examples; and,

FIG. 6 is a flow diagram of a method according to various examples.

The same part numbers designate the same or similar parts throughout the figures.

### DETAILED DESCRIPTION

One difficulty in organizations or enterprises is that increasingly high volumes of data objects are being received, created and stored. As the volume increases, finding relevant data objects within those stored becomes increasingly difficult. Advances in computer technology have provided users with numerous options for creating data objects such as electronic files and documents. For example, many common software applications executable on a typical personal computer enable users to generate various types of useful data objects. Data objects can also be obtained from remote networks, from image acquisition devices such as scanners or digital cameras, or they can be read into memory from a data storage device (e.g., in the form of a file). Modern computer systems enable users to electronically obtain or create vast numbers of data objects varying in size, subject matter, and format. Such data objects may be located, for example, on personal computers, on file servers, network attached storage or storage area networks, or on other storage media.

In general, content classification involves assigning a data object such as a document or file to one or more sets or classes of documents with which it has commonality—usually as a consequence of shared topics, concepts, ideas and subject areas.

In certain systems, content classification may be offered to provide a class assignment for a data object such as a document, email message, web page or other data object. In certain systems, content classification may be offered to enable processing of data objects based on their respective content. One difficulty with content classification is that classes assigned may be too general. A typical problem with classifying content is that the classes used are not sufficient to differentiate the data object from other data objects. For example, a classification of “Education” is not sufficient to differentiate between pre-school books, University textbooks or literature advertising night-school courses, all of which could validly be described as being on the subject of education.

In certain systems, content classification may be performed manually. A typical problem with manual classification is that it is a lengthy activity and requires knowledge of the domain of the content for accurate classification. Due to constraints on resources, manual classification is often only used to assign very high, abstract, levels of classification. A further problem with manual classification is that two people will often decide to classify a data object differently, reducing the usefulness of the classification because common classification terms cannot be relied upon for searching and similar activities.

In certain systems, content classification may be performed automatically by a computer system. A typical problem with automatic classification is that the system may be misled into selecting inappropriate or meaningless classifications. One problem is that an author of content may use the same term in many data objects even though they may be about different subjects. This can result in that author's data objects being given a different classification to others in the same field/domain. As a result, classification may be led to be by author rather than by content of the data object.

Accordingly, various examples described herein were developed to provide a system that enables determination of sub-topics from content of data objects having an existing class. In an example of the disclosure, a system comprises a data repository, a data object analyzer including at least one processor to execute computer program code to determine terms from content of one or more data objects of each of a plurality of classes and collate said terms in said data repository and a pattern analyzer including at least one processor to execute computer program code to determine, from the terms in the data repository, a sub-topic for a selected one of said plurality of classes, the sub-topic comprising a set of terms, the set of terms being common to the content of at least a subset of said data objects of the selected class and substantially absent from data objects outside of said selected class.

Advantages of the examples described herein include that existing classifications of data objects is used to guide selection of meaningful finer granularity sub-classifications.

An advantage is that each sub-topic is preferably selected so as to be a sparse (small) set of terms such as words that tend to appear together in data objects such as documents that belong to the class, and not in the data objects outside the class. An advantage is that the use of the discrimination that exists in the data between the different broad classes enables a meaningful set of fine grained sub-topics to be found. An advantage is that the specificity of the sub-topics is controlled in part by the sparsity (having a small number of discriminating terms in every sub-topic sub-topic). An advantage is that the combination of existing classes and sub-topics enables a greater scope of classification at both broad and at granular levels. Few terms cannot discriminate the broad class, but can capture a distinct sub-topic, and eventually with other such sub-topics cover all or most of the data objects in the broad class

An advantage is that the processing to identify sub-topics can be designed to be computationally efficient. Another advantage is that the sub-topics in the form of small groups of terms are easily understood and provide contextual insight into the individual classes, to the level that they automatically identify sub topics in tagged classes.

An advantage is that sub-classification of data objects such as documents enables users to more easily locate related documents. Another advantage is that sub-classification enables relationships between data objects to be identified. Another advantage is that sub-classification enables differences in topics of data objects to be identified.

Another advantage is that accuracy of data object processing tasks such as indexing, summarization, and clustering is improved or can be increased on demand when categorisation is found to be insufficiently granular by application of sub-classification to the classes requiring further granularity.

Another advantage is that many sources or types of existing classes can be utilized and different existing class types or class assignment mechanisms can be leveraged to provide different advantages.

As used herein, a “data object” or “document” refers to any electronically readable content whether stored in a memory, data repository, file, computer readable medium, as a transient signal or another medium and including, but not limited to, text documents, email messages, data communications, web pages, unstructured data, and electronic books. A data object may include non-textual content that can be translated into a set representation. For example, a data object may include sets of events, sets of logs, image or sound data with extractable features and/or its metadata which can be represented by terms describing the respective content.

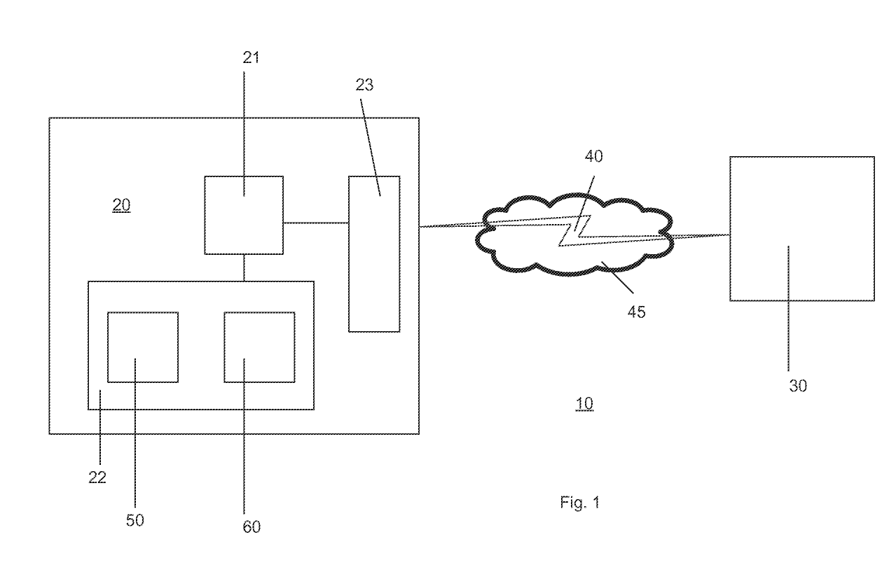

FIG. 1 is a block diagram illustrating a system, according to various examples. FIG. 1 includes particular components, modules, etc. according to various examples. However, in different examples, more, fewer, and/or other components, modules, arrangements of components/modules, etc. may be used according to the teachings described herein. In addition, various components, modules, etc. described herein may be implemented as one or more electronic circuits, software modules, hardware modules, special purpose hardware (e.g., application specific hardware, application specific integrated circuits (ASICs), embedded controllers, hardwired circuitry, Field Programmable Gate Arrays (FPGA), etc.), or some combination of these.

FIG. 1 shows a system 10. A computing device 20 is connected to a data repository 30 by a communications link 40. In one example, the communications link 40 is over a data communications network 45 which may be wired, wireless or a combination of wired and wireless networks. In another example, the communications link is a direct connection between the computing device 20 and the data repository 30 which may be wired or wireless. In one example, the communications link is a bus, USB, IEEE 1394 type, serial, parallel, IEEE 802.11 type, TCP/IP, Ethernet, Radio Frequency, fiber-optic or other type link and the client computer device includes a corresponding USB, IEEE 1394, serial, parallel, IEEE 802.11, TCP/IP, Ethernet, Radio Frequency, fiber-optic interface device, component, port or module to communicate over the communications link.

In one example, the computing device 20 is one of a desktop computer, an all-in-one computing device, a notebook computer, a server computer, a handheld computing device, a smartphone, a tablet computer, a print server, a printer, a self-service print kiosk, a subcomponent of a system, machine or device. In one example, the computer device 20 includes a processor 21, a memory 22, an Input/Output port 23. In one example, the processor is a central processing unit (CPU) that executes commands stored in the memory. In another example, the processor 21 is a semiconductor-based microprocessor that executes commands stored in the memory. In one example, the memory 22 includes any one of or a combination of volatile memory elements (e.g., RAM modules) and non-volatile memory elements (e.g., hard disk, ROM modules, etc.). In one example, the input/output port 23 is a logical data connection to a remote input/output port or queue such as a virtual port, a shared network queue or a networked print device.

In one example, the processor 21 executes computer program code from the memory 22 to execute a data object analyser 50 to determine terms from content of one or more data objects of each of a plurality of classes and collate the terms in the data repository 30.

In one example, terms are determined by the data object analyser by performing text processing operations on the content including stemming and removal of short words and/or predetermined stop words (such as “the”, “a” etc) to obtain terms that include individual words and/or word stems from the content. In one example, where content is not plain text, is graphical, audio or some mixture of content types, processing to interpret the content may be performed—for example to generate sets of distinct features that describe the graphical data object for example as a set of shapes, colors and/or properties such as persons, and locations; applying recognition techniques to extract terms from the graphical data or audio; stripping formatting and/or navigation from documents, emails, websites etc.; stripping formatting markup in the data object, extracting anomalies in signals, etc.

In one example, the processor 21 executes computer program code from the memory 22 to execute a pattern analyser 60 to determine, from the terms in the data repository 30, a sub-topic for a selected one of the plurality of classes, the sub-topic comprising a set of terms, the set of terms being common to the content of at least a subset of said data objects of the selected class and substantially absent from data objects outside of said selected class.

In one example, the pattern analyser determines a plurality of sub-topics for the selected one of the plurality of classes. Each sub-topic comprises a respective set of terms, each set of terms being common to the content of at least a subset of said data objects (and subsets may overlap so a data object may be a member of more than one subset) of the selected class and substantially absent from data objects outside of said selected class. In one example, a term appearing predominantly in the class and not predominantly in data objects outside of the class is substantially absent from data objects outside of the class. In one example, a term is assessed according to a metric or a weighted metric to determine if it is substantially absent from data objects outside of the class. In one example, a term having a predetermined magnitude of occurrences in a class relative to occurrences outside the class is substantially absent from data objects outside of the class. In one example, class membership is absolute, a term of a set of terms of a sub-topic of the class being absent from data objects outside of the selected class.

In one example, the pattern analyser is subject to optimisation criteria when determining the one or more sub-topics.

In one example, the optimisation criteria include selecting a sub-topic in which the number of data objects in the class with content common to the set of terms is maximised.

In one example, the optimisation criteria include minimising the number of terms in the set.

In one example, the optimisation criteria include minimising the number of occurrences of terms of the set in content of data objects outside of the class.

In one example, the one or more data objects are stored in the data repository 30. In another example, the one or more data objects are stored in one or more remote data repositories and accessed, for example over the data communications network 45.

In one example, the data object analyser 50 determines the plurality of classes for the data objects from data such as a tag in, or associated with, the data object. In another example, the data object analyser 50 assigns each of the data objects to one of a plurality of classes.

In one example, the data object analyser 50 and pattern analyser 60 are executed on separate computing devices. In one example, the data object analyser 50 and pattern analyser 60 are executed on a common computing device. In one example, the data object analyser 50 and pattern analyser 60 are sub-routines of a system executed by a computing device.

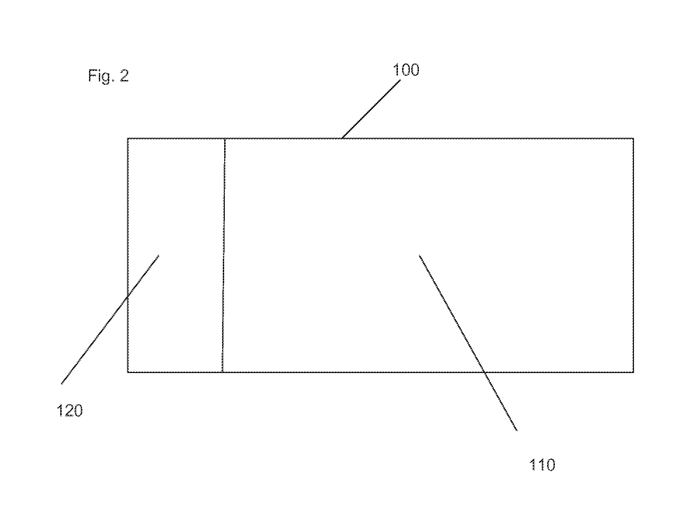

FIG. 2 is a schematic diagram illustrating elements of a data object 100, according to various examples. FIG. 2 includes particular components, modules, etc. according to various examples. However, in different examples, more, fewer, and/or other components, modules, arrangements of components/modules, etc. may be used according to the teachings described herein. In addition, various components, modules, etc. described herein may be implemented as software modules, data structures, encoded data, files, data streams or combinations of these.

FIG. 2 is a schematic diagram of a data object 100. The data object 100 includes content 110 such as raw or formatted text. The data object 100 also has an existing class and includes data 120 such as a tag or a set of tags identifying existing classes. In another example, the data on the existing class may not be stored with the data object and may be inherent or derived from the data object 100 or metadata or other data or knowledge on the data object 100.

In one example, the existing class is assigned by a remote and/or external system or source. In one example, the existing class is assigned manually or automatically according to a broad classification. For example, a broad classification may include classes of “Education”, “Politics”, “Fiction” and “Science”.

In one example, the existing class is inferred or determined from content such as presence of a particular keyword in the content; origin such as the person, organisation or application that authored the data object.

In one example, the existing class is inferred or determined from mechanism of transmission or receipt of the data object such as locally created data object, email data object, email attachment data object, web page data object.

In one example, the existing class is inferred or determined from the author, metadata or other attribute of the data object. In one example, the existing class is the area of expertise of the author of the data object.

In one example, the existing class is inferred from, or specified by, user inputs.

A sub-topic for a data object is a set of terms from the content 110 that are common to the content of the data object and other data objects of the class for which the sub-topic is selected as a discriminator.

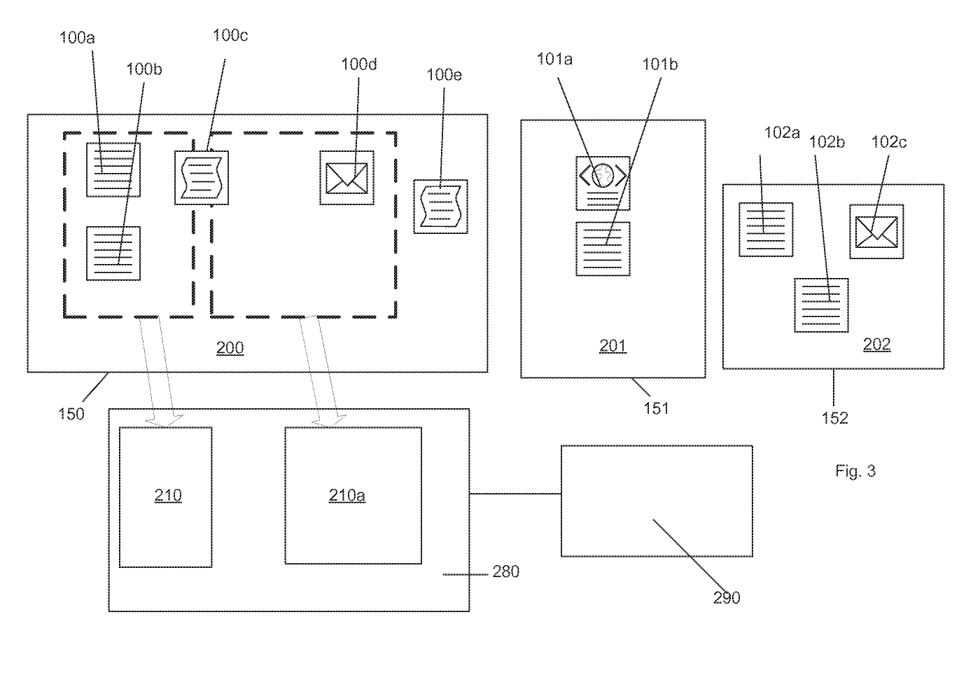

FIG. 3 is a block diagram illustrating a system, according to various examples. FIG. 3 includes particular components, modules, etc. according to various examples. However, in different examples, more, fewer, and/or other components, modules, arrangements of components/modules, etc. may be used according to the teachings described herein. In addition, various components, modules, etc. described herein may be implemented as one or more electronic circuits, software modules, hardware modules, special purpose hardware (e.g., application specific hardware, application specific integrated circuits (ASICs), embedded controllers, hardwired circuitry, Field Programmable Gate Arrays (FPGA), etc.), or some combination of these.

In one example, as shown in FIG. 3, the system 10 receives a designation of data objects 100a-100e of a first class 200 stored in a respective data repository 150, of data objects 101a-101b of a second class 201 stored in a respective data repository 151 and of data objects 102a-102c of a third class 202 stored in a respective data repository 152.

In one example, the system 10 determines one or more sub-topics for class. In another example, the system 10 determines one or more sub-topics for a designated one of the classes. For the purposes of illustration, determining sub-topics for the first class 200 is discussed, although the process is the same for further classes.

The system 10 determines, from the data objects 100a-100e of the class 200, two sub-topics 210, 210a, each comprising a set of terms common to the content of the data objects 100a-100e of the first class 200 and substantially not present in the content of data objects of the second 201 and third 202 classes. In the illustrated example, data objects 100a, 100b and 100c are determined to form a first sub-topic 201 and data objects 100c and 100d a second sub-topic. Data object 100c is a member of both sub-topics while data object 100e is not selected as a member of either sub-topic in this example. This reflects that in one example sub topics are not necessarily separate. Data object 100C in this example is part of both sub-topics. In one example sub-topics may not fully cover the whole class—data object 100e being part of the class but not being selected for either sub topic. In one example, the number of data objects in a class or a sub-topic is variable. The number of data objects shown in FIG. 3 is by way of example only. In one example, the two different sets of terms selected as sub-topics for an example first class of documents “Image Processing” may be:

scan; scanner; rbg; contrast; grayscal; noise

blurri; blur; motion; sharp; de-blur; convolut

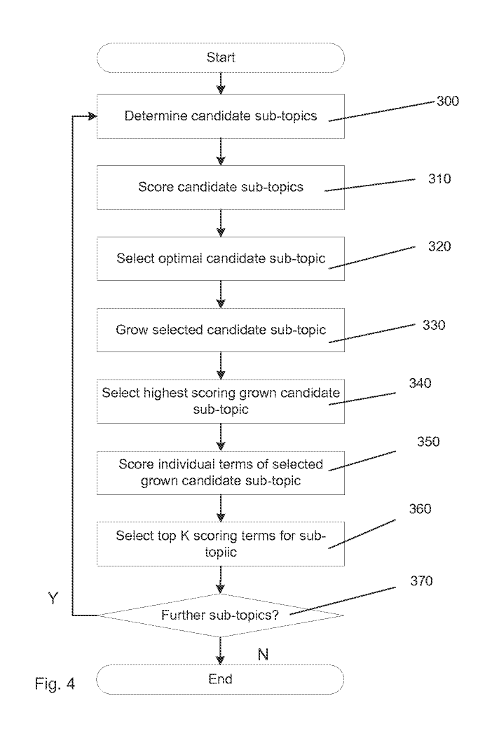

FIG. 4 is a flow diagram of operation in a method according to various examples. In discussing FIG. 4, reference may be made to the diagrams of FIGS. 1, 2, and 3 to provide contextual examples. Implementation, however, is not limited to those examples.

In one example, the system 10 determines the composition of the set iteratively.

At step 300, the system 10 determines multiple initial seeds of candidate sub-topics using different combinations of terms from one of the data objects 100a-100e of the class under consideration. In one example, multiple ones of the data objects of the class under consideration may be used as the source for different seeds.

Continuing at step 310, each candidate sub-topic is then scored in dependence on a metric, the metric including a measure of applicability of the set of terms of the candidate sub-topics to data objects of the class and to data objects not of the class.

Continuing at step 320, the candidate sub-topic (or optionally the top-N) having the most optimal score are retained and the others are discarded.

At step 330, the retained candidate sub-topics are grown by adding a new, different, term from the content of the source data object to each respective set such that the maximum metric score is achieved for the candidate sub-topic. The processing iterates a number of times until candidate sub-topics reach a predetermined size of terms.

At step 340, the candidate sub-topic having highest metric score is selected.

At step 350, the terms for the candidate sub-topic are individually scored against the metric and the top K terms are selected to form a sub-topic for the class 200.

At step 360, a decision is made whether further sub-topics are to be determined and, if so, data on terms used for the sub-topic is removed from consideration on documents in the subtopic and operation loops back to step 300.

In one example, data on the class and sub-topic(s) are written to a database 280 or other data repository with a link or other association to the respective data objects of the class that have content common to the terms of the sub-topic.

In one example, the database 280 is used as an index for a search, clustering or data summarization system 290 with the class and sub-topic acting as the index and the link to the data object acting as the indexed item.

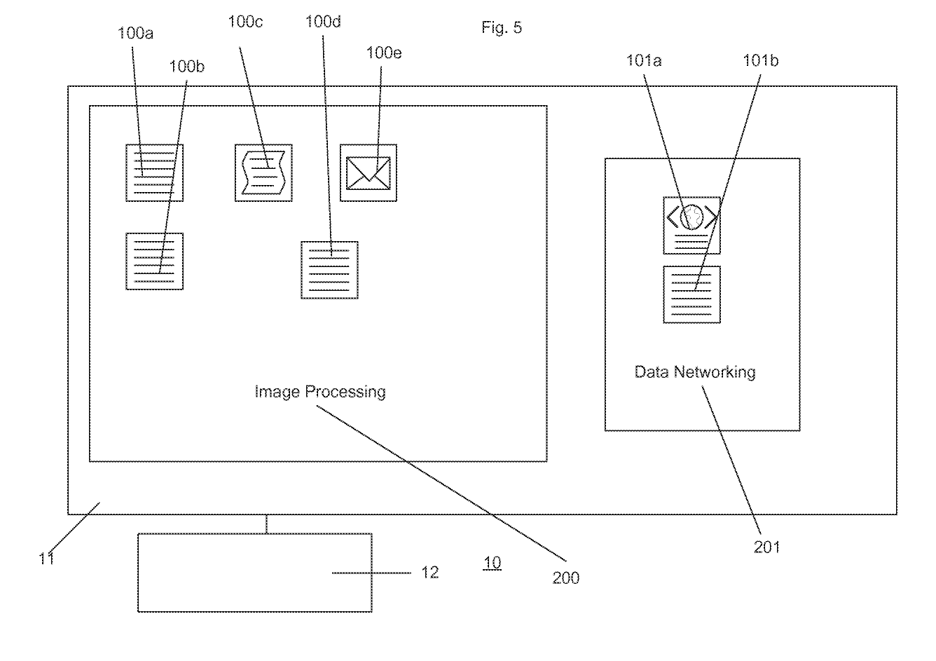

FIG. 5 is a block diagram illustrating a system, according to various examples. FIG. 5 includes particular components, modules, etc. according to various examples. However, in different examples, more, fewer, and/or other components, modules, arrangements of components/modules, etc. may be used according to the teachings described herein. In addition, various components, modules, etc. described herein may be implemented as one or more electronic circuits, software modules, hardware modules, special purpose hardware (e.g., application specific hardware, application specific integrated circuits (ASICs), embedded controllers, hardwired circuitry, Field Programmable Gate Arrays (FPGA), etc.), or some combination of these.

In one example, as shown in FIG. 5, the system 10 outputs, via a user interface 11, a visual representation of data objects 100a-100e of a first class 200 stored in a respective data repository 150, and of data objects 101a-101b of a second class 201 stored in a respective data repository 151.

In one example, the system 10 receives, via an input/output interface 12, a user input designating one or more of the classes and a user input designating an analysis operation.

In one example, the analysis operation designated is a “zoom” operation that causes the system 10 to return a predetermined number of sub-topics and links to representative documents (data objects). If the zoom analysis operation is repeatedly performed, the predetermined number of sub-topics returned is increased on each repetition (which, while dependent on the content of the data objects, will generally have the effect of increasing the number of terms in each sub-topic in order for multiple distinct sub-topics to be determined and therefore increases the perceived zoom level).

In one example, the analysis operation designated is a “diff” operation that takes as parameters via the user interface 11 and input/output interface 12 a designation of two classes or more (or a designation of a subset of data objects from the classes) and causes the system 10 to return sub-topics that are unique to the first of the two or more classes (or subset of data objects of the class).

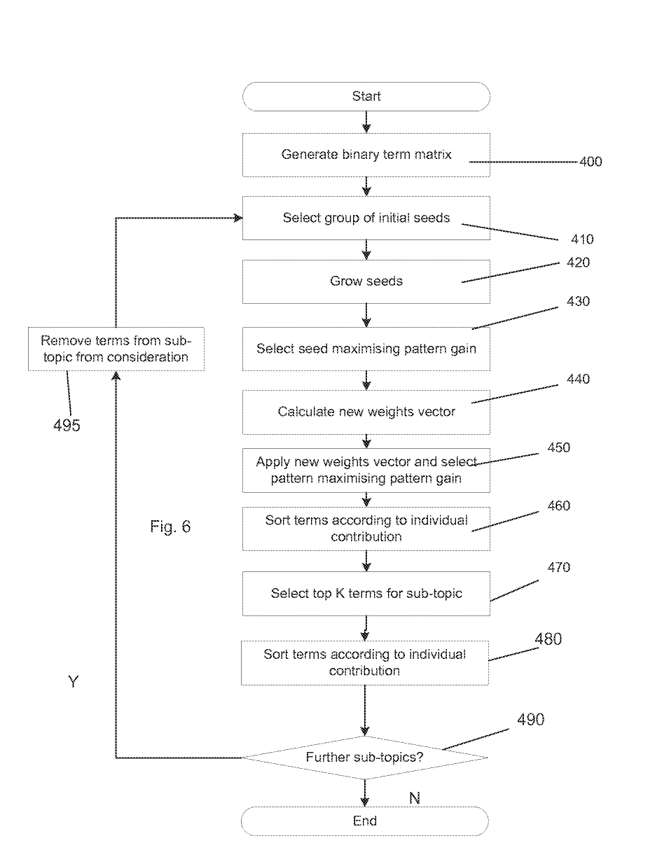

FIG. 6 is a flow diagram of operation in a method according to various examples. In discussing FIG. 6, reference may be made to the diagrams of FIGS. 1, 2, 3, 4 and 5 to provide contextual examples. Implementation, however, is not limited to those examples.

FIG. 6 is a flow diagram depicting steps taken to implement various examples.

Starting at step 400, a binary data object-term matrix A is generated to represent the terms of the data objects of the classes under consideration.

Aε{0,1}^{[n×m]}

where Aᵢⱼ=1 only if the i^{th} data object contains the j^{th} term in the set of terms representing the data object.
Each row of matrix A represents terms from a respective data object.

The matrix A is dependent on the data objects under consideration but is typically very sparse and the number of unique terms is usually very large. Each document has an associated class. In the following discussion, it is assumed that there are t classes C={c₁, . . . , cₜ}, and each document is associated to only one class (single tagging). However, in another example the described approach is applied to multi-tagging, where all the data objects tagged to the class are used as C and the others as C̅. In another example, ‘close classes’ are determined (e.g. those which have many commonly tagged documents), in which case only those data objects which are not tagged to C or to its close classes are used as C.

The notation A_{c} refers to rows of the matrix A representing data objects in class c while A _{c̅} refers to rows of the matrix A representing data objects in the rest of the rows (data objects outside class c).
A binary sparse pattern vector is used as the basis for analysis of patterns of terms:

Xε{0,1}^{[m×1]}

where Xᵢ=1 if the i^{th} word participates in the pattern.
The notation |X| represents the number of words that belong to the pattern vector X. Note that the multiplication AX=Y yields a counter vector that holds in the j^{th} entry the number of words that belong to X and appear in the j^{th} data object.
A weights vector is used to guide operation to find relatively rare sub-topics that appear in a relatively small subset of data objects of a class while at the same time finding enough sub-topics to cover most or all of the data objects in the class:

WεR^{[n×1]} where Σⱼ₌₁ⁿWⱼ=1, ∀ⱼWⱼ≧0

Weights vector W_{c} denotes the weights vector for A_{c} and W _{c̅} denotes the weights vector for A _{c̅}
A pattern weight (PW), a weighted LP-norm of Y is calculated as:

$$PW ( X , A \cdot W ) = {‖ AX ‖}_{W}^{p} = \sqrt[p]{{\sum }_{j = 1}^{n} {W}_{j} {Y}_{j}^{p}}$$

where Y=AX and
p≧1 and is a system parameter (discussed below).
A pattern gain (PG), a measure of the difference between pattern weight inside the class and pattern weight outside the class is calculated as:

PG(X,A_{c},A _{c̅},W_{c},W _{c̅})=∥A_{c}X∥_{W}_{_{c}}^{p}−λ∥A _{c̅}X∥W _{c̅}^{p}

Where λ≧1 and is a parameter.
A pattern that has a high pattern gain measured for a specific class is a good discriminative pattern and possible candidate as a sub-topic.

In one example, weights vectors and are initialized as:

$${W}_{c} = \frac{1}{\vert {A}_{c} \vert} and {W}_{\overline{c}} = \frac{1}{\vert {A}_{\overline{c}} \vert}$$

System parameters are initialized as:

p_{high}=2 and p_{low}=1

λ=1

Tₛ (seed size)=5

Tₚ (pattern maximal size)=20

Ns (number of seeds grown in parallel)=10

Continuing at step 410, a group of initial seeds is selected. In one example, the parameter p in this stage is set to be high (typically close to 2).

An initial seed has a small number of terms and is selected as follows:

p=p_{high}=2
{lᵢ} are indicator vectors with 1 only on the i^{th} location. Indicator vectors are vectors that contain a value of either 1 or 0 (or some other binary equivalent indicator). An indicator vector indicates index sets (the indices in which they have a value of 1). In this case the indicator vectors indicate a single index each.
Pattern gain for each is calculated:

PG(Iᵢ,A_{c},A _{c̅},W_{c},W _{c̅})=∥∥A_{c}Iᵢ∥∥_{W}_{_{c}}^{p}−λ∥∥A _{c̅}Iᵢ∥∥_{W}_{_{c}}^{p}
The {i₁, . . . , i_{N}_{ₛ}} indicator vectors that maximize pattern gain are determined and the group of seeds is set to

[X₁^{s}=I₁_{ₛ}, . . . ,X_{N}_{ₛ}^{s}=Iᵢ_{_{N}}]

At step 420, the group of seeds is iteratively grown Tₛ times.
For each Xᵢ^{s}, 1≦i≦Nₛ, the next term to add to the pattern is selected so as to maximize pattern gain (PG):

j=argmax_{j′}{PG(Xᵢ^{s}∪I_{j′},A_{c},A _{c̅},W_{c},W _{c̅})}

Xᵢ^{s}=Xᵢ^{s}∪Iⱼ

At step 430, the single seed maximizing pattern gain is selected as output of the seed estimation stage:

i=argmax_{i′}PG(X_{i′}^{s}),X^{s}=Xᵢ^{s}

Pattern estimation is then performed. The parameter p is set to be low (typically close to 1). At step 440, the seed maximizing pattern gain that is selected as output of the seed estimation stage in step 430 is used to calculate a new weights vector for A_{c} as follows:

$${W}_{c} = {A}_{c} * {X}^{s} , {W}_{c} = \frac{{W}_{c}}{\vert {W}_{c} \vert}$$

The new weights vector assigns high weighting to data objects that include most of the seed's terms (and therefore would expected to share the same sub-topic).

At step 450, the newly calculated weights vector is used to find the pattern of terms that maximizes pattern gain. Since p is set to p_{low} (typically close to or equal to 1), the pattern gain is linear and the contribution of each term i to the pattern gain can be computed independently as follows:

PGᵢ(Iᵢ,A_{c},A _{c̅},W_{c},W _{c̅})=W_{c}^{T}*A_{c}−W _{c̅}^{T}*A _{c̅}

In step 460, terms are sorted according to their individual contribution:

idxₜₑᵣₘₛ=sort(PGᵢ(Iᵢ,A_{c},A _{c̅},W_{c},W _{c̅}))

In step 470, the K terms determined from the sort to have the highest contribution are selected to yield a K term pattern. In one example, K is selected to be larger than seed size Tₛ and smaller than the pattern maximal size Tₚ. In one example, pattern size is selected in dependence on magnitude of individual contributions of terms. In one example, a pattern size is selected to include terms up to a maximal decrease in individual contribution in the sorted terms.

In step 480 the K term pattern is stored in a memory as a sub-topic.

In step 490, a check is performed to decide if further sub-topics should be identified. In one example, the check is dependent on the analysis operation being performed. In one example, the check is dependent on whether all data objects of the class under consideration fall within at least one determined sub-topic. In one example, the check is dependent on the number of sub-topics determined. If further sub-topics are to be identified, A_{c} is updated to remove the entries for the K terms in data objects matching the K term pattern and W_{c} is updated to assign more weight to data objects not yet matched to a sub-topic in step 495. Operation then loops to step 410.

The algorithm is iterative, on each iteration one pattern is extracted and removed from the data. The parameter p steers operation of the algorithm. High p drives selection of combinations of terms that appear together, even if they appear in just a few data objects, whereas low p drives selection of more common terms that appear in many data objects, even if not always together. Choosing p to be high leads to focus on very rare words that appear in just a few documents whereas choosing p to be lower results in less granular sub-topics being selected that cover more data objects. In one example, p is controlled by use of the categorization.

The functions and operations described with respect to, for example, the data object analyser and/or pattern analyser may be implemented as a computer-readable storage medium containing instructions executed by a processor and stored in a memory. Processor may represent generally any instruction execution system, such as a computer/processor based system or an ASIC (Application Specific Integrated Circuit), a Field Programmable Gate Array (FPGA), a computer, or other system that can fetch or obtain instructions or logic stored in memory and execute the instructions or logic contained therein. Memory represents generally any memory configured to store program instructions and other data.

Various modifications may be made to the disclosed examples and implementations without departing from their scope. Therefore, the illustrations and examples herein should be construed in an illustrative, and not a restrictive, sense.

What is claimed is:

1. A system comprising:
a data repository;
a data object analyser including at least one processor to execute computer program code to determine terms from content of one or more data objects of each of a plurality of classes and collate said terms in said data repository;
a pattern analyser including at least one processor to execute computer program code to determine, from the terms in the data repository, a sub-topic for a selected one of said plurality of classes, the sub-topic comprising a set of terms, the set of terms being common to the content of at least a subset of said data objects of the selected class and substantially absent from data objects outside of said selected class.

2. The system of claim 1, wherein the at least one processor of the pattern analyser further executes computer program code to perform an optimisation operation to select terms for the sub-topic.

3. The system of claim 2, wherein the at least one processor of the pattern analyser further executes computer program code to perform the optimisation operation including maximising the number of data objects in the class with content common to the set of terms and minimising the number of terms in the set.

4. The system of claim 2, wherein the at least one processor of the pattern analyser further executes computer program code to perform the optimisation operation including minimising the number of occurrences of terms of the set in content of data objects outside of the class.

5. The system of claim 1, wherein the at least one processor of the data object analyser further executes computer program code to determine the class for each data object from one or more of:
data on the class in the data object; data on the class associated with the data object; metadata on the data object; data determined from content of the data object; origin of the data object; mechanism of transmission or receipt of the data object; type of data object; author of the data object; area of expertise of the author of the data object.

6. The system of claim 1, further comprising at least one processor to execute computer program code to receive one or more user inputs specifying the class.

7. The system of claim 1, further comprising at least one processor to execute computer program code to cause a graphical representation of at least selected ones of the data objects to be displayed grouped according to their respective classes and sub-topic.

8. The system of claim 7, further comprising at least one processor to execute computer program code to receive one or more inputs specifying the class, wherein for each user input specifying the class, the at least one processor of the pattern analyser executing the computer program code to determine, from the terms in the data repository, a sub-topic for the selected class at an increased granularity.

9. The system of claim 7, further comprising at least one processor to execute computer program code to receive inputs specifying a first class and a second class, the at least one processor of the pattern analyser executing the computer program code to determine, from the terms in the data repository, a sub-topic common to the first class comprising terms absent from the second class.

10. A non-transitory computer-readable storage medium containing instructions to determine one or more sub-topics for a class of data objects, the instructions when executed by a processor causing the processor to:
determine terms from content of one or more data objects of each of a plurality of classes and collate said terms;
determine, from the terms, a sub-topic for a selected one of said plurality of classes, the sub-topic comprising a set of terms common to the content of at least a subset of said data objects of the selected class and substantially absent from data objects not of said selected class.

11. The non-transitory computer-readable storage medium of claim 10, wherein the instructions when executed by the processor further cause the processor to perform an optimisation operation to select terms for the sub-topic including maximising the number of data objects in the class with content common to the set of terms, minimising the number of terms in the set and minimising the number of occurrences of terms of the set in content of data objects not of the class.

12. The non-transitory computer-readable storage medium of claim 10, wherein the instructions when executed by the processor further cause the processor to access data to determine the class for each data object from one or more of:
data on the class in the data object; data on the class associated with the data object; metadata on the data object; data determined from content of the data object; origin of the data object; mechanism of transmission or receipt of the data object; type of data object; author of the data object; area of expertise of the author of the data object.

13. The non-transitory computer-readable storage medium of claim 10, wherein the instructions when executed by the processor further cause the processor to cause a graphical representation of at least selected ones of the data objects to be displayed on a display according to their respective classes and sub-topic.

14. The non-transitory computer-readable storage medium of claim 10, wherein the instructions when executed by the processor further cause the processor to receive one or more inputs specifying the class, and for each user input specifying the class, to determine a sub-topic for the selected class at an increased granularity.

15. The non-transitory computer-readable storage medium of claim 10, wherein the instructions when executed by the processor further cause the processor to receive inputs specifying a first class and a second class, and to determine a sub-topic for one or more data objects of the first class comprising terms absent from the second class.

16. The non-transitory computer-readable storage medium of claim 10, wherein the instructions when executed by the processor further cause the processor to determine, from one or more of the data objects of the selected class, a plurality of candidate sub-topics, each candidate sub-topic comprising a set of terms common to the content of one or more data objects of the selected class;
score each candidate sub-topic in dependence on a metric, the metric including a measure of applicability of the set of terms of the candidate sub-topic to data objects of the selected class and to data objects not of the selected class; and,
select the sub-topic from the plurality of candidate sub-topic in dependence on the scores.

17. A method for determining a sub-topic for a class of data objects, the class being one of a plurality of classes, the method comprising:
determining, from one or more of the data objects of said class, a plurality of candidate sub-topics, each candidate sub-topic comprising a set of terms common to the content of the one or more data objects of the class;
scoring each candidate sub-topic in dependence on a metric, the metric including a measure of applicability of the set of terms of the candidate sub-topic to data objects of the class and to data objects not of the class;
selecting a sub-topic from the plurality of candidate sub-topic in dependence on the scores; and,
writing data on the sub-topic to a memory, including data on the set of terms and an association to the class and to data objects having content common to the terms of the sub-topic.

18. The method of claim 17, wherein prior to the step of selecting a sub-topic, the method further comprising, for each candidate sub-topic:
selecting a term from the content of a data object of the set having content common to the terms of the respective sub-topic such that the maximum metric score is achieved for the candidate sub-topic; and,
adding the term to the sub-topic.

19. The method of claim 18, further comprising repeating the steps of selecting and adding the term.

20. The method of claim 18, wherein the step of selecting a sub-topic further comprises scoring each candidate sub-topic in dependence on the metric and selecting at least a subset of the terms for the sub-topic in dependence on their respective scores.
